(19) United States
(12) Patent Application Publication
(10) Pub. No.: US 2025/0012951 A1
(43) Pub. Date: Jan. 9, 2025

(54) OPTICAL ELEMENT FOR MULTIPLE REFLECTIONS OF STRAY LIGHT

(71) Applicant: GENIUS ELECTRONIC OPTICAL (XIAMEN) CO., LTD., Xiamen (CN)

(72) Inventors: Junya Liu, Xiamen (CN); Weisen Cai, Xiamen (CN); Ziping Li, Xiamen (CN)

(73) Assignee: GENIUS ELECTRONIC OPTICAL (XIAMEN) CO., LTD., Xiamen (CN)

(21) Appl. No.: 18/637,471

(22) Filed: Apr. 17, 2024

(30) Foreign Application Priority Data
Jul. 7, 2023 (CN) 202310833735.1

(51) Int. Cl. G02B 5/02

(52) U.S. Cl. CPC G02B 5/0284

(57) ABSTRACT

An optical element for multiple reflections of stray light includes a plurality of microstructures configured around a central axis of the optical element. Each of the microstructures includes a first reflective surface and a second reflective surface which are in contact, and has a connection line, which is a boundary line between the first reflective surface and the second reflective surface. An extension line of the connection line passes through the central axis, where the plurality of microstructures are arranged in a plurality of rings adjacent to each other, and the plurality of microstructures of two adjacent rings in the rings are alternately arranged with each other.

### CROSS-REFERENCE TO RELATED APPLICATION

This application claims the priority benefit of Chinese application no. 202310833735.1, filed on Jul. 7, 2023. The entirety of the above-mentioned patent application is hereby incorporated by reference herein and made a part of this specification.

### BACKGROUND

### Technical Field

The disclosure relates to an optical element, and in particular to an optical element for multiple reflections of stray light.

### Description of Related Art

In an optical system, stray light causes problems such as a reduction in contrast, a trouble of ghost image, and a decrease in signal-to-noise ratio, which reduces imaging quality. Therefore, how to effectively suppress the stray light is particularly important in optical design.

The conventional method for suppressing the stray light is to configure a microstructure on a surface of an optical element. However, when light relative to an incident angle of the surface is too large, for example, incident ray of the stray light is parallel to the surface with the microstructure in the optical element, the stray light easily enters a photosensitive element of an imaging system after one reflection from the microstructure, so that a suppression effect of the stray light is very small.

In related art, microstructure design using a millimeter structure plus a nanostructure is also adopted. However, due to the cumbersome processing and manufacturing process, the cost is high and the popularization is not easy. Although the stray light with the large incident angle may be suppressed, the attenuation effect of the stray light is still limited when the incident angle of the stray light relative to a flat surface of the microstructure is 90°. In addition, how does the optical element with the microstructure on the surface release a mold smoothly after molding is also a problem to be solved by the relevant manufacturers.

### SUMMARY

The disclosure provides an optical element, which may greatly suppress stray light, so that an optical system with the optical element may effectively improve optical quality.

In an embodiment of the disclosure, the optical element for multiple reflections of the stray light includes a plurality of microstructures around a configuration of a central axis of an optical element, each of a microstructure includes a first reflective surface and a second reflective surface in contact, and has a connection line, which is a boundary line between the first reflective surface and the second reflective surface. An extension line of the connection line passes through the central axis, where the plurality of microstructures are arranged in a plurality of rings adjacent to each other, and the plurality of microstructures of two adjacent rings in the plurality of rings are alternately arranged with each other.

In another embodiment of the disclosure, an optical element for multiple reflections of the stray light includes a plurality of microstructures around a configuration of a central axis of an optical element, and each of a microstructure includes a base, an apex, and a first reflective surface and a second reflective surface in contact with each other formed from the base and the apex, and has a connection line, which is a boundary line between the first reflective surface and the second reflective surface. Moreover, orthographic projections of the first reflective surface and the second reflective surface on the base form an angle, and an extension line of an angle bisector of the angle passes through the central axis, where the plurality of microstructures are arranged in a plurality of rings adjacent to each other, and the plurality of microstructures of two adjacent rings in the plurality of rings are alternately arranged with each other.

Based on the above, in the optical element of the disclosure, since the extension line of the connection line of the reflective surface of the microstructure passes through the central axis, it is suitable for splitting the stray light from a radial direction. Moreover, through design of an alternate arrangement of the plurality of rings formed by the microstructure around the central axis, the stray light incident between the microstructure is reflected multiple times by the reflective surfaces of the microstructures alternately arranged. Every time the stray light is reflected once, intensity of the stray light is greatly attenuated once. Through multiple light splits and reflections on the reflective surface of the microstructure, the stray light at different incident angles is effectively and greatly suppressed. When the incident angle of the stray light is 90°, that is, when the incident direction of the stray light is parallel to the base of the microstructure, the stray light enters the second ring from gaps between the microstructure of the first ring, where a reflection time between the microstructures may reach a maximum, reduces a chance of the stray light leaving the plurality of microstructures with only one reflection, and further attenuates the stray light to a minimum.

In order to make the above features and advantages of the disclosure more comprehensible, the following specific embodiments are described in detail together with the accompanying drawings.

### BRIEF DESCRIPTION OF THE DRAWINGS

FIG. 1 is a schematic view of a lens according to a first embodiment of the disclosure.

FIG. 2 is a top schematic view of a second optical element according to the first embodiment.

FIG. 3 is an enlarged schematic view of a region A in FIG. 2.

FIG. 4 is a schematic view of a light splitting principle of a plurality of microstructures according to the first embodiment.

FIG. 5 is an enlarged schematic view of a microstructure according to the first embodiment.

FIG. 6 is a top schematic view of a second optical element according to a second embodiment of the disclosure.

FIG. 7 is an enlarged schematic view of a region A′ in FIG. 6.

FIG. 8 is a schematic view of a light splitting principle of a plurality of microstructures according to the second embodiment.

FIG. 9 is an enlarged schematic view of the microstructure according to the second embodiment.

FIG. 10 is a top schematic view of an object side of a third optical element according to a third embodiment.

FIG. 11 is an enlarged schematic view of a surface of the third optical element in FIG. 10.

FIG. 12 is a cross-sectional schematic view of the third optical element in FIG. 10.

FIG. 13 is a cross-sectional enlarged schematic view of a surface of the third optical element in FIG. 12.

FIG. 14 is a derivative schematic view of a range of a theoretical maximum reflection time and the range of a theoretical minimum reflection time between two microstructures of the disclosure.

FIG. 15 is a cross-sectional schematic view of a microstructure of the disclosure.

FIG. 16 to FIG. 18 are optical simulation views of reflection times of stray light at different angles on a base of the microstructure of the disclosure.

### DESCRIPTION OF THE EMBODIMENTS

The usages of “approximately,” “similar to,” “essentially,” or “substantially” indicated throughout the specification include the indicated value and an average value having an acceptable deviation range, which is a certain value confirmed by people skilled in the art, and is a certain amount considered the discussed measurement and measurement-related deviation (i.e., the limitation of measurement system). For example, “approximately” may indicate to be within one or more standard deviations of the indicated value, such as being within ±30%, ±20%, ±15%, ±10%, or ±5%. Furthermore, the usages of “approximately,” “similar to,” “essentially,” or “substantially” indicated throughout the specification may refer to a more acceptable deviation scope or standard deviation depending on measurement properties, cutting properties, or other properties, and all properties may not be applied with one standard deviation.

Exemplary embodiments are described herein with reference to cutaway section views that are schematic views of idealized embodiments. As such, variations in the shapes of the figures as a result, for example, of manufacturing techniques and/or tolerances are to be expected. Therefore, the embodiments described herein should not be construed as limited to the particular shapes of regions as shown herein but are to include deviations in shapes that result from, for example, manufacturing. For example, a region illustrated or described as flat, may typically, have rough and/or non-linear features. In addition, the acute angle shown may be a rounded corner in actual production, so the angle included by the two sides may be the included angle measured between the extension lines of the two sides. For another example, a side length of a polygon (for example, three side lengths of a triangle) may refer to the distance between the intersection points of the extension lines of the two sides adjacent to each other. Therefore, the regions shown in the figures are essentially schematic, and the shapes of the regions in the figures are not intended to illustrate the precise shape of the region.

References of the exemplary embodiments of the disclosure are to be made in detail. Examples of the exemplary embodiments are described in the accompanying drawings. If applicable, the same element signs in the drawings and the descriptions indicate the same or similar parts.

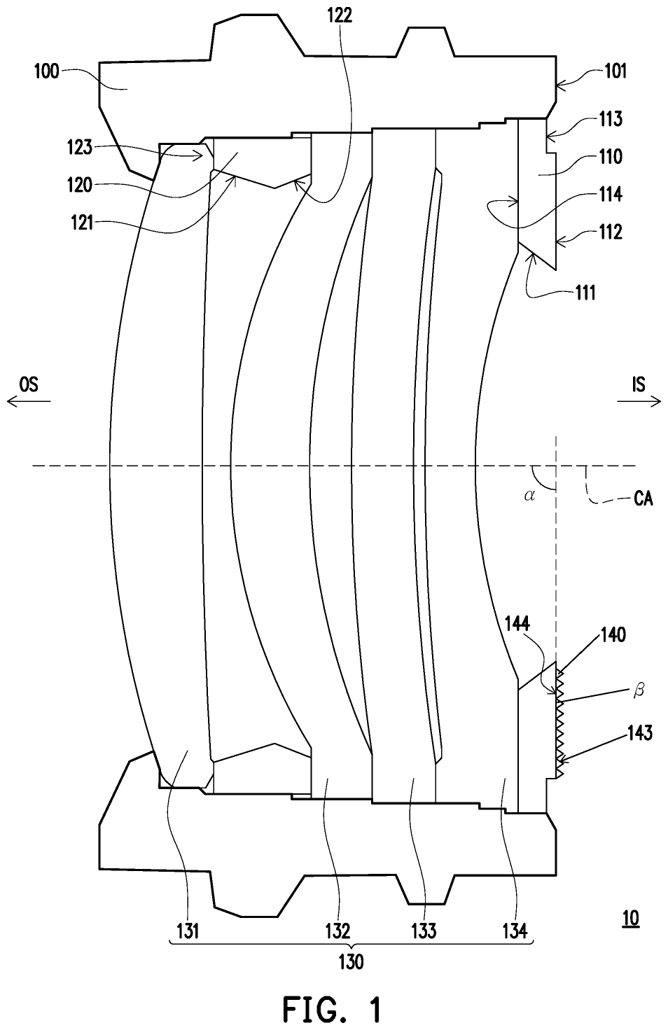

FIG. 1 is a schematic view of a lens according to a first embodiment of the disclosure. With reference to FIG. 1 first, a lens 10 of the disclosure includes a first optical element 100, a second optical element 110, a third optical element 120, and a lens group 130. The first optical element 100 is, for example, a lens barrel of the lens 10, and has a space for accommodating the second optical element 110, the third optical element 120, and the lens group 130. It is worth mentioning that the lens 10 and the optical axes of and the optical elements may be configured coaxially. In other words, the lens 10, the first optical element 100, the second optical element 110, the third optical element 120, and the lens group 130 may all be axisymmetric optical elements. Further, the first optical element 100, the second optical element 110, and the third optical element 120 may be annular optical elements, and each symmetry axis of the elements is a central axis CA. Moreover, the central axes CA of the elements coincide with each other to have the common central axis CA. The second optical element 110 is, for example, a fixing ring of the lens 10, and the third optical element 120 is, for example, a spacer or a spacer ring of the lens 10. A fixed surface 114 of the second optical element 110 and a fixed surface 123 of the third optical element 120 may be used to fix the lens group 130, and a focusing component (unillustrated) may be used to move the lens 10 relative to an image side IS to achieve the purpose of adjusting a focal length of the lens 10, but the disclosure is not limited thereto.

The lens group 130 may include a first lens element 131, a second lens element 132, a third lens element 133, and a fourth lens element 134 arranged in sequence from an object side OS to the image side IS. A material of each lens of the lens group 130 may be glass or plastic. However, the disclosure does not limit a quantity of each lens in the lens group 130, where light from the object side OS may pass through the first lens element 131, the second lens element 132, the third lens element 133, and the fourth lens element 134 and transmit to a photosensitive element (unillustrated) on the image side IS in sequence, and the photosensitive element senses the light from outside and converts it into an image. However, when the light enters the lens 10, unexpected reflection inevitably occurs on an inner surface of the lens 10 or an interface between the lens group 130 and air to form stray light, thereby affecting the imaging quality of the photosensitive element. In order to solve the above problems, the first optical element 100, the second optical element 110, and the third optical element 120 of the disclosure may each include a plurality of microstructures 140 around a configuration of the central axis CA of the first optical element 100, the second optical element 110, and the third optical element 120.

Specifically, the first optical element 100 may have a surface 101 around the central axis CA and facing the image side IS, and the plurality of microstructures 140 may be configured on the surface 101 of the first optical element 100 and protrude toward the image side IS, so that the plurality of microstructures 140 are also around the configuration of the central axis CA.

In addition, the second optical element 110 also includes a surface 111 around the central axis CA, a surface 112 around the central axis CA, and a surface 113 around the central axis CA. The surface 111 faces the radial direction of the lens 10 and forms an angle with the central axis CA, for example, 42 degrees; the surface 112 faces the image side IS, and the surface 113 faces the image side IS, and is located between the surface 101 of the first optical element 100 and the surface 112 of the second optical element 110 in the radial direction of the lens 10, and the plurality of microstructures 140 may be configured on the surface 111, the surface 112, and the surface 113 of the second optical element 110, so that the plurality of microstructures 140 are also around the configuration of the central axis CA.

Similarly, the third optical element 120 may also include a surface 121 and a surface 122 around the central axis CA, and the plurality of microstructures 140 may be configured on the surface 121 and the surface 122 of the third optical element 120 and protrude toward the central axis CA, so that the plurality of microstructures 140 are also around the configuration of the central axis CA. It is worth mentioning that, in a cross section of the lens 10, the angles between the surface 121 and the surface 122 and the central axis CA may be substantially the same or different.

For example, the angle between the central axis CA and the central axis CA on the surface 121 may be substantially 20 degrees, which means that the surface 121 is substantially inclined at 20 degrees relative to the central axis CA. However, the disclosure is not limited thereto. In other unillustrated embodiments, the plurality of microstructures 140 may also be configured on the inner surface of the first optical element 100, which means that in the radial direction of the first optical element 100, the surface faces the lens group 130 without touching the lens group 130 may also be configured with the plurality of microstructures 140, but the disclosure is not limited thereto.

As mentioned above, in order to present a configuration relationship of each element in FIG. 1, the plurality of microstructures 140 are only schematically illustrated on a lower edge of the surface 112 of the second optical element 110 (below the central axis CA in FIG. 1), and in fact, a configuration location and an arrangement method of the plurality of microstructures 140 may refer to the aforementioned paragraphs, and are not repeated herein. It is worth mentioning that, through the design and the arrangement of the plurality of microstructures 140 of the disclosure, the stray light is incident to the plurality of microstructures 140 may be effectively split and absorbed. Hereinafter, the plurality of microstructures 140 of the second optical element 110 and the third optical element 120 are exemplarily explained.

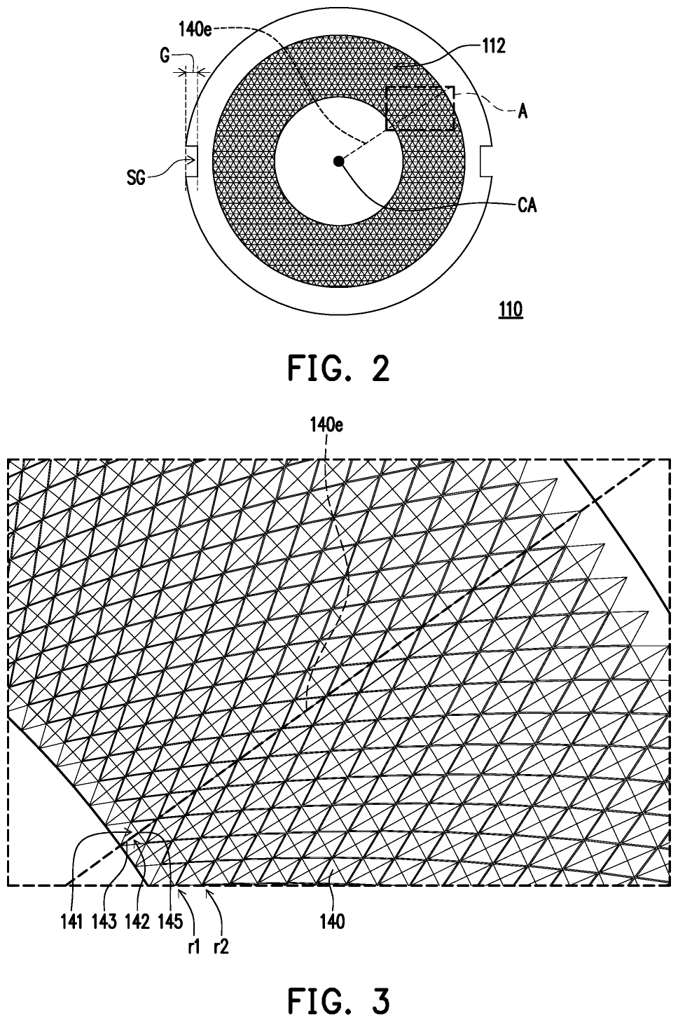

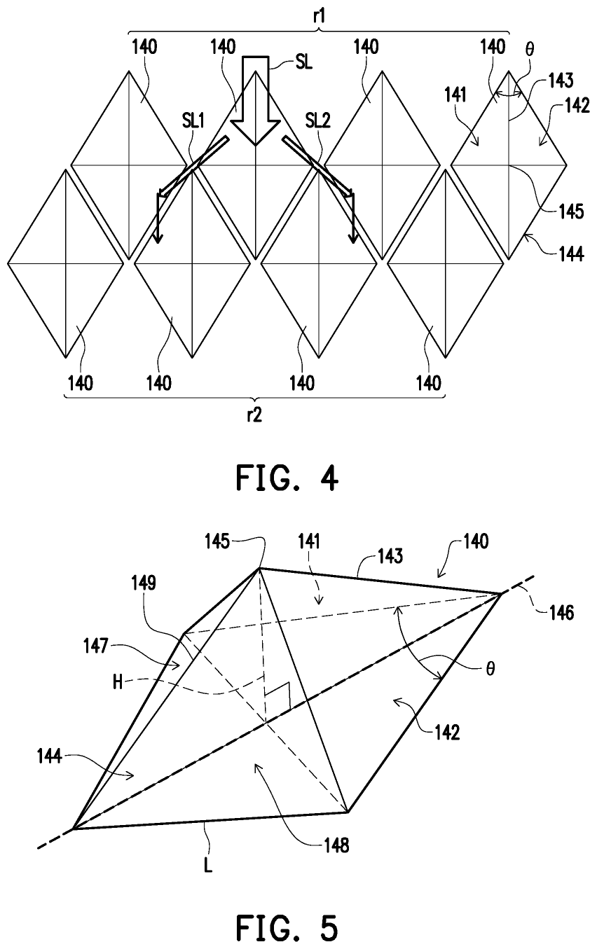

FIG. 2 is a top schematic view of a second optical element according to the first embodiment. FIG. 3 is an enlarged schematic view of a region A in FIG. 2. FIG. 4 is a schematic view of a light splitting principle of a plurality of microstructures according to the first embodiment. FIG. 5 is an enlarged schematic view of the microstructure according to the first embodiment. With reference to FIG. 2 to FIG. 4 at the same time, each of the plurality of microstructures 140 on the surface 111, the surface 112, and the surface 113 of the second optical element 110 includes a first reflective surface 141 and a second reflective surface 142 which are in contact, and has a connection line 143, which is a boundary line between the first reflective surface 141 and the second reflective surface 142. An extension line 140e of the connection line 143 passes through the central axis CA, where the plurality of microstructures 140 are arranged in a plurality of rings adjacent to each other, and in the radial direction of the second optical element 110, the plurality of microstructures 140 of two adjacent rings are alternately arranged with each other. From another perspective, FIG. 3 is taken as an example. The plurality of microstructures 140 include a first ring r1 and a second ring r2 arranged to be the symmetry axis about the central axis CA, and the first ring r1 is closely adjacent to the second ring r2. Moreover, the first ring r1 is closer to the central axis CA than the second ring r2, and “alternate arrangement” may refer to that the connection line 143 of the microstructure 140 on the first ring r1 and the connection line 143 of the microstructure 140 on the second ring r2 do not coincide with each other, and each of the connection line 143 points to the central axis CA. Furthermore, the microstructure 140 on the second ring r2 are configured in the gaps between the microstructure 140 on the first ring r1.

Next, with reference to FIG. 4, when light enters the lens 10 along the central axis CA (i.e., the optical axis of the lens 10), part of the light forms stray light SL, and part of the stray light SL irradiates the plurality of microstructures 140 on the surface 112 of the second optical element 110 along the radial direction of the lens 10. Since the extension line 140e of the connection line 143 of the first reflective surface 141 and the second reflective surface 142 of the microstructure 140 passes through the central axis CA, the stray light SL is easily reflected, refracted, and absorbed by the first reflective surface 141 and the second reflective surface 142 of the microstructure 140 after irradiating the second optical element 110, and is further split into first sub-stray light SL1 and second sub-stray light SL2.

Since the plurality of microstructures 140 are around the central axis CA to form the plurality of rings adjacent to each other and alternately arranged (for example, the first ring r1 and the second ring r2), the first sub-stray light SL1 and the second sub-stray light SL2 and then are reflected, refracted, and absorbed by the first reflective surface 141 and the second reflective surface 142 of the plurality of microstructures 140 of the second ring r2 alternately arranged after reflected by the microstructure 140 of the first ring r1 and leaving the first ring r1, and continue to be split and attenuated. Likewise, the stray light SL is also be further reflected, refracted, and absorbed by the microstructure 140 of the adjacent plurality of rings in sequence subsequently (for example, an unillustrated third ring, an unillustrated fourth ring, etc.) after reflected by the microstructure 140 of the second ring r2 and leaving the second ring r2. Through the layout and the configuration of the microstructure 140 as mentioned above, a probability of the stray light SL leaving the plurality of microstructures 140 after only one reflection by the microstructure 140 may be greatly reduced, which is beneficial to the attenuation of the stray light SL.

Under consideration on the basis of further optimizing the effect of attenuating the stray light SL, an appropriate material may be selected to adjust reflectivity of the microstructure 140.

In some embodiments, the reflectivity of the material of the microstructure 140 may be less than 5%, which means that without considering refraction, a ratio of a total power of the first sub-stray light SL1 and the second sub-stray light SL2 to the power of the stray light SL may be less than 1/20. Moreover, through every reflection by the microstructure 140 of each of a ring, the power of the stray light SL is reduced to 1/20 of the original reflection after the reflection, and intensity of the stray light SL may be attenuated to a minimum by multiple reflections.

FIG. 5 is an enlarged schematic view of the microstructure according to the first embodiment. Next, with reference to FIG. 5, in this embodiment, the microstructure 140 may be substantially a pyramid, for example, a quadrangular pyramid as shown in FIG. 5. Besides the first reflective surface 141, the second reflective surface 142, and the connection line 143, the microstructure 140 also has a base 144, an apex 145, a third reflective surface 147, a fourth reflective surface 148, and a connection line 149. The base 144 may be in contact with the first reflective surface 141 and the second reflective surface 142, and the connection line 149 passes through the apex 145 and is in contact with another point on the base 144. The base 144 may be in contact with the third reflective surface 147 and the fourth reflective surface 148, and the connection line 149 passes through the apex 145 and is in contact with another point on the base 144. The connection line 149 is the boundary line between the third reflective surface 147 and the fourth reflective surface 148. Each of a microstructure 140 is a pyramid with the apex 145, which is beneficial to increase the probability of multiple reflections between the stray light SL incident to the microstructure 140. However, the disclosure is not limited thereto.

It is worth mentioning that the base 144 of the microstructure 140 includes an angle θ, and the value of the angle θ is less than 90°. Through the design that the angle θ is substantially an acute angle, relative to an obtuse angle, the second optical element 110 may be positioned in a circumferential direction (i.e., an angular direction of polar coordinates), and surface density of the microstructure 140 on the surface 111, the surface 112, and the surface 113 may be further improved, which is beneficial to increase the probability of the reflection time of the stray light SL from the radial direction.

Further, an extension line of an angle bisector 146 of the angle θ may pass through the central axis CA. In other words, the projection of the extension line 140e of the connection line 143 on the base 144 may coincide with the extension line of the angle bisector 146 of the angle θ.

Through the symmetrical design of the first reflective surface 141 and the second reflective surface 142 of the microstructure 140, structural complexity of the microstructure 140 may be reduced, and manufacturing difficulty of the microstructure 140 and the mold for manufacturing the microstructure 140 may be simplified. However, the disclosure is not limited thereto. In some embodiments, the orthographic projections of the first reflective surface 141 and the second reflective surface 142 on the base 144 also form an angle θ, where extension line of the angle bisector 146 of the angle θ passes through the central axis CA, and the connection line 143 between the first reflective surface 141 and the second reflective surface 142 may not pass through the central axis CA, so that there is a slight deviation. The above design may also achieve the effect of splitting the stray light SL from the radial direction by the first reflective surface 141 and the second reflective surface 142. The orthographic projections of the third reflective surface 147 and the fourth reflective surface 148 on the base 144 also form an angle θ, where the extension line of the angle bisector 146 of the angle θ also passes through the central axis CA.

The microstructure 140 may be processed on the surface 111, the surface 112, and the surface 113 of the second optical element 110 by using a laser engraving process, for example.

The second optical element 110 and the plurality of microstructures 140 thereon may also be manufactured by injection of molding and the plastic material. For example, in FIG. 2, the second optical element 110 manufactured to be molding by injection may include a gate SG and have a proper depth of a gate G. Specifically, when the diameter of the second optical element 110 is substantially 6.89 millimeters (mm) and the thickness is substantially 0.325 mm, the depth of the gate G in the radial direction may be substantially 0.2 mm, and vertical heights of the microstructures 140 are all 0.060 mm. The dimension of the shortest side length of the base 144 of the microstructure 140 ranges from 0.051 mm to 0.077 mm. However, the disclosure is not limited to the size of the optical elements.

With reference to FIG. 1 and FIG. 5, it is worth mentioning that the more configuration number of the microstructure 140 is, the better attenuation of the stray light SL is, but the size of the microstructure 140 is further reduced, which makes it difficult to release the mold during the manufacturing process. In order to strike a balance between the effectiveness of eliminating the stray light SL and the difficulty of manufacturing, the microstructure 140 may satisfy the following relation equation during manufacturing: α+β≤180°, α≥90°, β<90°, where α is an angle between the base 144 and the central axis CA, and the β is an angle between the base 144 and the connection line 143. That is, the angle α is an obtuse angle formed by the base 144 and the central axis CA.

From another perspective, on the cross-section of the lens 10, the angle α is a supplementary angle of an acute angle formed by the central axis CA and the projection of the central axis CA on the surface 112. In this embodiment, the angle α is a right angle between the base 144 and the central axis CA, and the angle β is 50 degrees. Since the microstructure 140 is configured on the surface 112, the base 144 of the microstructure 140 may substantially coincide with the surface 112.

The above only uses the surface 112 of the second optical element 110 as an exemplary description, and a configuration method of the plurality of microstructures 140 on the surface 111 and the surface 113 of the second optical element 110 and the configuration method of the plurality of microstructures 140 on the surface 101 of the first optical element 100 may refer to the aforementioned paragraphs, and are not be repeated herein. Since the first optical element 100 may be a lens barrel as mentioned above, the surface 101 is configured with the microstructure 140 which enables the stray light SL transmitted to the image side IS but not absorbed by the second optical element 110 to be further absorbed by the surface 101 of the first optical element 100. The second optical element 110 may be a fixing ring, and the third optical element 120 may be a spacer. Each of the above elements may also achieve the effect of reducing the stray light SL in the lens 10.

Other embodiments are described below to explain the disclosure in detail, where the same components will be denoted by the same reference numerals, and the description of the same technical content will be omitted. For the description of the omitted part, reference may be made to the above embodiment, and are not repeated hereafter.

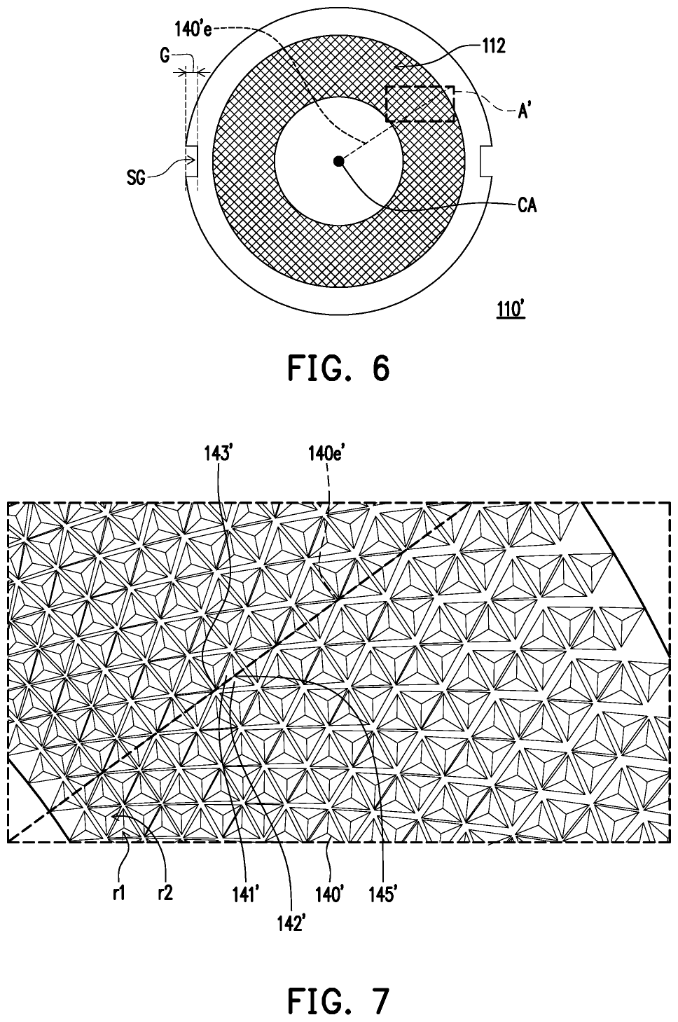

FIG. 6 is a top schematic view of a second optical element according to a second embodiment. FIG. 7 is an enlarged schematic view of a region A′ in FIG. 6. With reference to FIG. 6 and FIG. 7 at the same time, the second optical element 110′ of this embodiment is similar to the second optical element 110 in FIG. 2. Each of the plurality of microstructures 140′ includes a first reflective surface 141′ and a second reflective surface 142′ which are in contact, and has a connection line 143′, which is the boundary line between the first reflective surface 141′ and the second reflective surface 142′. An extension line 140′e of the connection line 143′ passes through the central axis CA, where the plurality of microstructures 140′ are arranged in the plurality of rings adjacent to each other, and in the radial direction of the second optical element 110′, the plurality of microstructures 140′ of two adjacent rings (for example, the first ring r1 and the second ring r2) are alternately arranged with each other. The difference between the second optical element 110′ and the second optical element 110 lies in that the shapes of the microstructures are different. Specifically, the shape of the base 144′ of the plurality of microstructures 140′ of the second optical element 110′ is substantially a triangle.

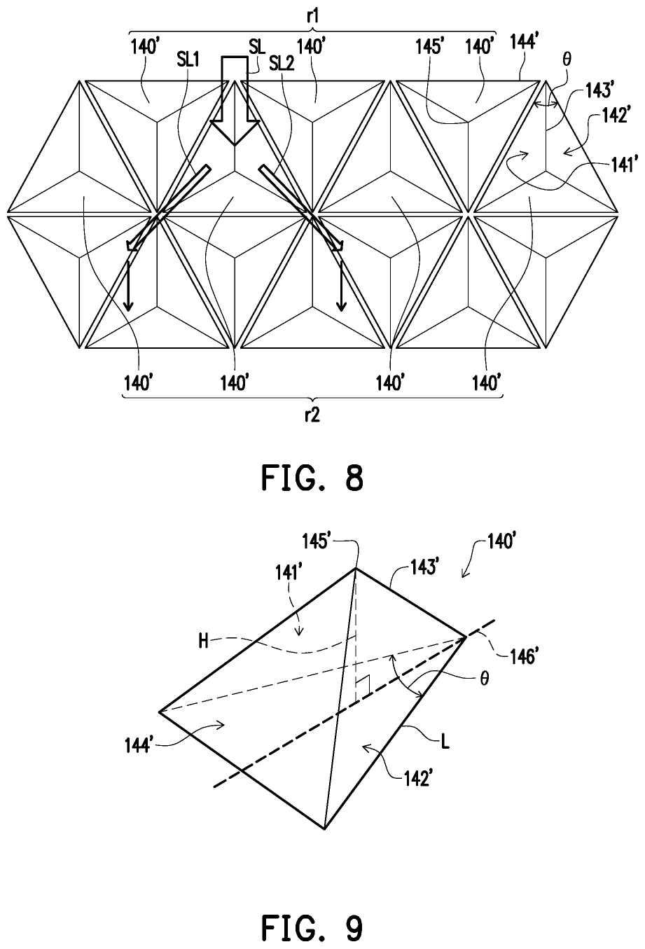

FIG. 8 is a schematic view of a light splitting principle of a plurality of microstructures according to the second embodiment. FIG. 9 is an enlarged schematic view of the microstructure according to the second embodiment. With reference to FIG. 8 to FIG. 9 at the same time, narrowly speaking, the plurality of microstructures 140′ of the second optical element 110′ may also achieve the light splitting effect of the second optical element 110 in FIG. 4. For example, the first reflective surface 141′ and the second reflective surface 142′ of the microstructure 140′ are also suitable for splitting the stray light SL from the radial direction into the first sub-stray light SL1 and the second sub-stray light SL2, and the stray light SL continues to be split and reflected by the microstructure 140′ on the adjacent second ring r2 and subsequent other adjacent rings after passing through the microstructure 140′ of the first ring r1. Further, since the shape of the base 144′ of the microstructure 140′ is substantially a triangle, the more plurality of microstructures 140′ may be configured on the surface 112 than on a quadrilateral on the basis of the same area.

The number of total reflective surfaces of the plurality of microstructures 140′ on the second optical element 110′ is further increased, and the reflection times of the stray light SL between the plurality of microstructures 140′ are increased, which is beneficial to further attenuate the stray light SL.

Similar to the extension line of the angle bisector 146 of the microstructure 140 passing through the central axis CA, one of the angle θ of the base 144′ of the microstructure 140′, the extension line of the angle bisector 146′ may also pass through the central axis CA, so as to further achieve the effect of splitting the stray light SL by using the first reflective surface 141′ and the second reflective surface 142′. Relevant content may refer to the aforementioned paragraphs, and is not repeated herein.

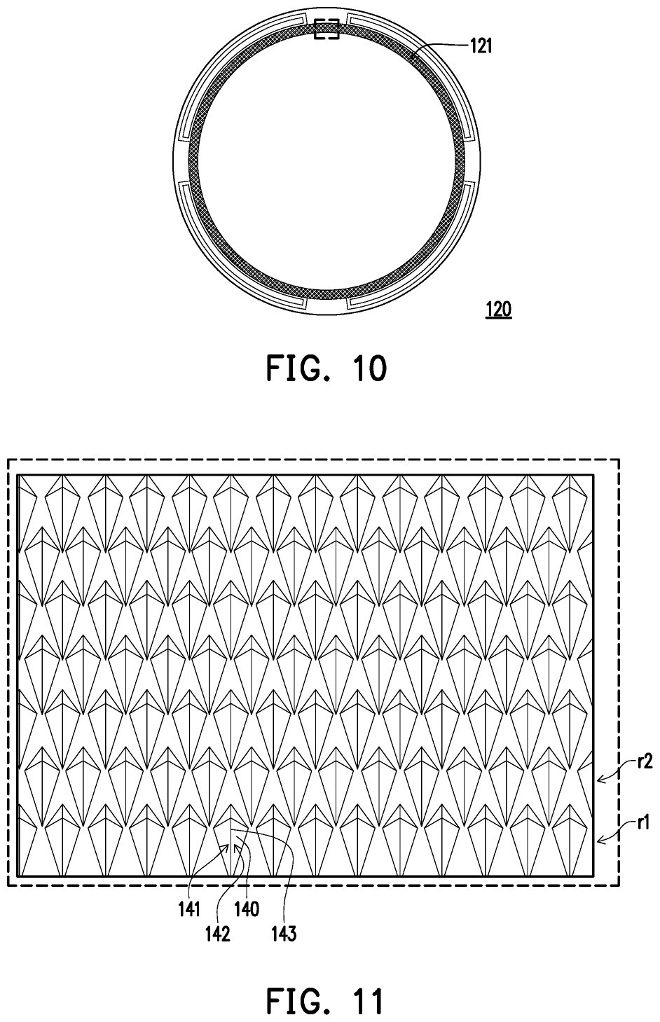

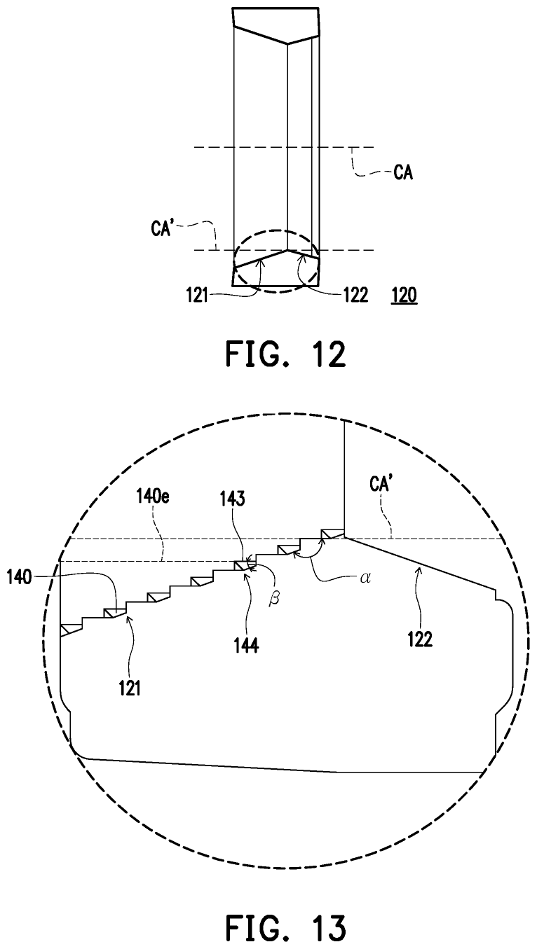

FIG. 10 is a top schematic view of an object side of a third optical element according to a third embodiment. FIG. 11 is an enlarged schematic view of a surface of the third optical element in FIG. 10. FIG. 12 is a cross-sectional schematic view of the third optical element in FIG. 10. FIG. 13 is a cross-sectional enlarged schematic view of a surface of the third optical element in FIG. 12. With reference to FIG. 10 to FIG. 13 at the same time, the surface 121 and the surface 122 of the third optical element 120 may both be configured with the plurality of microstructures 140. In order to clearly present the angular relationship of the microstructure 140, an illustration of the plurality of microstructures 140 on the surface 122 is omitted in FIG. 13.

Similarly, the plurality of microstructures 140 on the surface 121 and the surface 122 may also be arranged alternately with each other to form the plurality of rings, and the microstructures 140 of two adjacent rings (for example, the first ring r1 and the second ring r2 in FIG. 11) may be arranged alternately with each other. As shown in FIG. 11 and FIG. 13, each of the plurality of microstructures 140 includes a first reflective surface 141, a second reflective surface 142 and has a connection line 143, which is the boundary line between the first reflective surface 141 and the second reflective surface 142. An extension line 140e of the connection line 143 passes through the central axis CA. In order to conveniently present the relationship between the extension line 140e and the central axis CA, the auxiliary line CA′ is used to replace the central axis CA in the enlarged cross-sectional schematic view in FIG. 13, and the auxiliary line CA′ is substantially an axis parallel to the central axis CA. Thus, the angle between the surface 121 and the surface 122 and the auxiliary line CA′ is equal to the angle between the surface 121 and the surface 122 and the central axis CA. The principle of eliminating the stray light SL by the microstructure 140 on the third optical element 120 may refer to the aforementioned second optical element 110 in FIG. 4 and the second optical element 110′ in FIG. 8, and is not repeated herein.

With reference to FIG. 13, it is worth mentioning that the more configuration number of the microstructure 140 is, the better attenuation of stray light SL is, but the size of the microstructures 140 is further reduced, which makes it difficult to release the mold during the manufacturing process. In order to strike a balance between the effectiveness of eliminating stray light SL and the difficulty of manufacturing, the microstructure 140 may satisfy the following relation equation during manufacturing: α+β≤180°, α≥90°, β<90°, where α is an angle between the base 144 and the central axis CA, and β is an angle between the base 144 and the connection line 143. That is, the angle α is an obtuse angle formed by the base 144 and the central axis CA.

From another perspective, on the cross-section of the lens 10, the angle α is a supplementary angle of the acute angle formed by the central axis CA and the projection of the central axis CA on the surface 121. In this embodiment, the angle α is 160°, and the angle β is 20°. Since the microstructure 140 is configured on the surface 121 and the surface 122, the base 144 of the microstructure 140 may substantially coincide with the surface 121 or the surface 122.

It should be noted that since the shape of the base 144 of the microstructure 140 is a quadrilateral, but is not limited to an equal side length L of each side. For example, in the enlarged view of the surface 121 in FIG. 11, the shape of the base 144 of the microstructure 140 may be substantially a kite. The above connection line 143 refers to one of the longest connection lines in the base 144. The base 144 is taken as the kite as an example, and the connection line 143 refers to the long axis of the kite. The extension line 140e of the connection line 143 is the extension of the long axis of the kite.

In other embodiments, in order to make the plurality of microstructures 140 consistent, and to make a spacing tolerance between the adjacent microstructures 140 smaller than the shortest side length L of the microstructure 140, which is beneficial to reduce the probability of the stray light SL incident to the microstructure 140 for one reflection, the microstructures 140 may further satisfy the following relation equation: 90°≤α≤135°, and the difference in angle θ of the bases 144 of each of the plurality of microstructures 140 is less than or equal to 5°. However, the disclosure is not limited thereto. In other embodiments, the microstructures 140 may further satisfy the following relation equation: 90°≤α≤135°, and the difference between the maximum side lengths L of the bases 144 of each of the plurality of microstructures 140 is less than or equal to 5%.

A plurality of side lengths L of the microstructure 140 in FIG. 5 as mentioned above (or the microstructure 140′ in FIG. 9) may all be substantially equal, or two adjacent side lengths L are substantially equal, or a side length L of each side are all substantially unequal, but the disclosure is not limited thereto. It should be noted that the first optical element 100 in FIG. 1, the second optical element 110 in FIG. 2, the second optical element 110′ in FIG. 6, and the third optical element 120 in FIG. 10, where the spacing between the bases 144 of the plurality of microstructures 140 is located in the same ring in the plurality of rings, or the spacing between the bases 144′ of the plurality of microstructures 140′ may all be smaller than the shortest side length L of the microstructure 140 (or the microstructure 140′). Here, “distance” refers to the minimum distance between the edge of the base 144 and the edge of another base 144 adjacent to the same ring. Through the above, the actual spacing tolerance of the adjacent plurality of microstructures 140 may be smaller than the shortest side length L of the microstructures 140, which is beneficial to reduce the probability of only one reflection of the stray light SL incident to the microstructures 140.

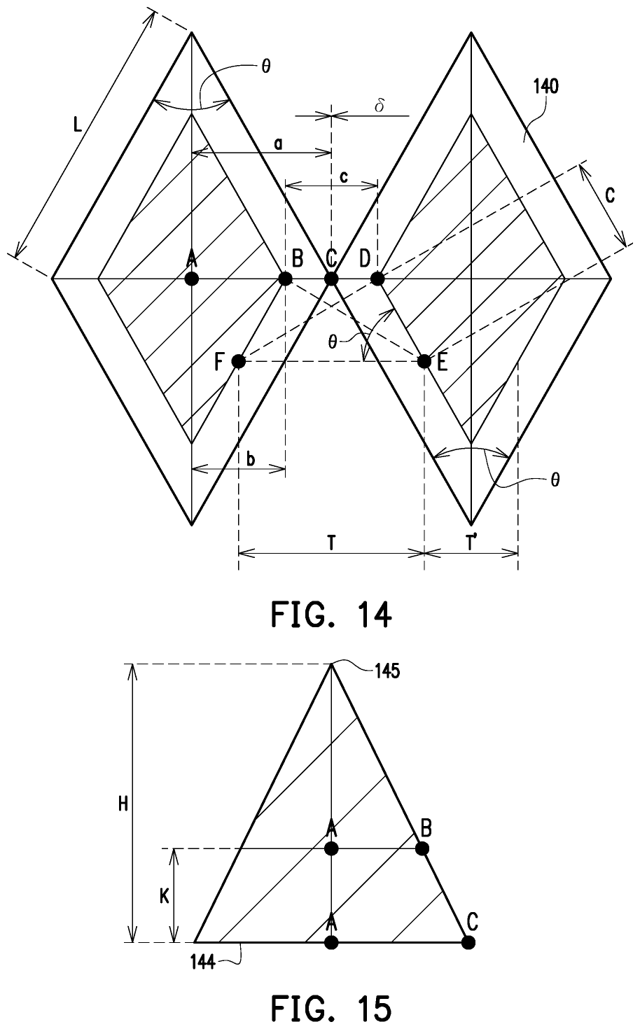

FIG. 14 is a derivative schematic view of a range of a theoretical maximum reflection time and the range of the theoretical minimum reflection time between microstructures of the disclosure. FIG. 15 is a cross-sectional schematic view of a microstructure of the disclosure.

The conditions of each parameter between the microstructures 140 (or microstructures 140′) are further explained now. With reference to FIG. 14 and FIG. 15 at the same time, an incident angle of the stray light SL is assumed 90°, that is, it is parallel to the base 144 of the microstructure 140 and irradiates point E or point F of the microstructure 140, and is reflected to point B and point D of the microstructure 140. Moreover, the vertical height between point B and point D and the base 144 is K, and the base 144 of the microstructure 140 is rhombus, so the length L of each side of the base 144 is equal. The vertical height from the apex 145 of the microstructure 140 to the base 144 is the height H, and the angle between the base 144 facing the incident direction of the stray light SL is the angle θ. The horizontal distance AB between the irradiated position at the height K and the height H is the length b. The distance AC between the half of the shorter diagonal in the base 144 is the length a, and the distance BD is the length c. When the stray light SL is incident between the plurality of microstructures 140 and the range falls within T, the stray light SL may be reflected by the microstructures 140 of the first row (for example, the aforementioned first ring r1) and transmitted to the microstructures 140 of the second row (for example, the aforementioned second ring r2) and continues to be reflected, so T is the range of the maximum reflection time. Conversely, when the stray light SL is incident on the microstructure 140 and the range falls within T′, the stray light SL will be reflected to the microstructure 140 of the same row (and the first ring r1) after being reflected by the microstructure 140, and is not transmitted to the microstructure 140 of the next row (i.e., the second ring r2), so T′ is the range of the minimum reflection time.

Through the trigonometric relationship, it may be known that a=L*cos (90°−θ/2), and the similarity ratio in FIG. 15: (H−K)/H=AB/AC=b/a, it may be known that b=a*(H−K)/H.

Moreover, through the geometric relationship, c=2(a−b)+δ is obtained, where δ is a spacing between the two microstructures 140. On the other hand, BDE is an isosceles triangle, so BD=DE=c. DEF is a right triangle of cos θ, so T=c/cos θ. Then the above a, b, and c are respectively substituted into T=2*K*L*cos(90°−θ/2)/H*cos θ+δ/cos θ. T′=(a−T/2)*2. For example, when θ is 60°, and H and L are equal, T=2K+2δ, T′=L−2K−2δ.

Through the above, the angle θ of the base 144 of the microstructure 140 may satisfy the following relation equation: 55°≤θ≤65°. For the stray light SL with an incident angle of 90° (that is, when the incident direction of the stray light SL is substantially parallel to the base 144), the theoretical maximum reflection time may reach a maximum value. However, the disclosure is not limited thereto. In other embodiments, the angle θ of the base 144 of the microstructure 140 may satisfy the following relation equation: 35°≤θ≤45°. For the stray light SL with an incident angle of 90°, the theoretical minimum reflection time of is more than 55°≤θ≤65°. In some embodiments, in order to satisfy the range T of the maximum reflection time, the range T′ of the minimum reflection time, and cooperate with the lens 10 with a length of 3 mm to 50 mm in the direction of the central axis CA, the microstructure 140 may satisfy the following relation equation: 0.45 μm/degrees≤H/θ≤9.1 μm/degrees. In some embodiments, the microstructure 140 may also satisfy the following relation equation: 0.45 μm/degrees≤L/θ≤9.1 μm/degrees, where L is the shortest side length L of the base 144. In other embodiments, the microstructure 140 may also satisfy the following relation equation: 0.6≤H/L≤1.0. Definitions of relevant parameters may refer to the aforementioned paragraphs, and are not repeated herein. Through the above parameter ranges, the microstructure 140 may theoretically satisfy the range T of the maximum reflection time and the range T′ of the minimum reflection time.

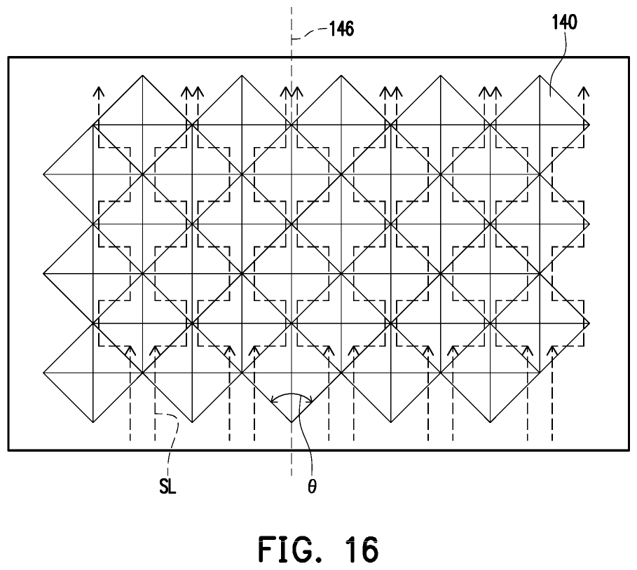

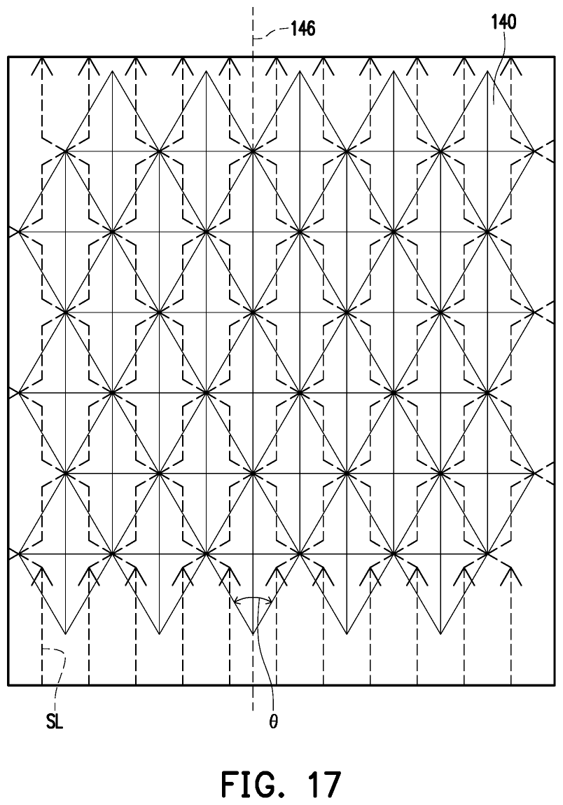

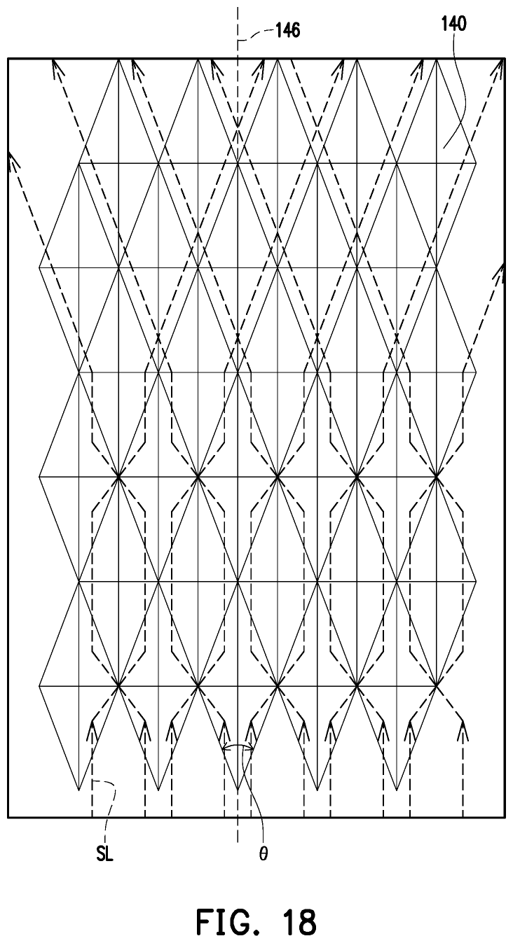

FIGS. 16 to 18 are optical simulation views of reflection times of the stray light at different angles on the base of the microstructure of the disclosure. FIGS. 16 to 18 are 30 microstructures 140 and are arranged in a 6*5 array; the side length of the microstructure 140 is 0.06 mm; the stray light SL is irradiated to the height of 0.02 mm from the base 144. The difference is that the extension of the angle bisector 146 of the angle θ in FIG. 16 passes through the central axis CA, and the angle θ=90°. The angle bisector 146 of the angle θ in FIG. 17 passes through the central axis CA, and the angle θ=60°. The angle bisector 146 of the angle θ in FIG. 18 passes through the central axis CA, and the angle θ=40°. Through the optical simulations, it may be known that when θ=90° in FIG. 16, the maximum reflection time is 10, and the minimum reflection time is 2. When θ=60° in FIG. 17, the maximum reflection time is 12, and the minimum reflection time is 2. When θ=40° in FIG. 18, the maximum reflection time is 10, and the minimum reflection time is 5. From the above preliminary analysis, it may be known that the smaller the angle θ is, the better multiple reflections of the stray light SL between the interfaces are. However, too small an angle also leads to problems such as difficult processing and difficult molding of the plurality of microstructures 140.

Based on the above, in the optical element of the disclosure, since the extension line of the connection line of the reflective surface of the microstructure passes through the central axis, it is suitable for splitting the stray light from the radial direction. Moreover, through design of an alternate arrangement of the plurality of rings formed by the microstructure around the central axis, the stray light incident between the microstructure is reflected multiple times by the reflective surfaces of the microstructures alternately arranged. Every time the stray light is reflected once, intensity of the stray light is greatly attenuated once. Through multiple light splits and reflections on the reflective surface of the microstructure, the stray light at different incident angles is effectively and greatly suppressed.

When the incident angle of the stray light is 90°, that is, when the incident direction of the stray light is parallel to the base of the microstructure, the reflection time of the stray light reflected by the first ring and entering the second ring may reach the maximum value, reduce a chance of the stray light leaving the plurality of microstructures with only one reflection, and further attenuates the stray light to the minimum.

The ranges of the aforementioned optical parameters, the aforementioned comparative relations between the optical parameters, and the maximum value, the minimum value, and the numerical range between the maximum value and the minimum value of the aforementioned conditional expressions are all implementable and all belong to the scope disclosed by the disclosure. The aforementioned description is for exemplary explanation, but the disclosure is not limited thereto.

The embodiments of the disclosure are all implementable. In addition, a combination of partial features in a same embodiment may be selected, and the combination of partial features may achieve the unexpected result of the disclosure with respect to the prior art. The combination of partial features includes but is not limited to the surface shape, the angle, and the conditional expression, or a combination thereof. The description of the embodiments is for explaining the specific embodiments of the principles of the disclosure, but the disclosure is not limited thereto.

Specifically, the embodiments and the drawings are for exemplifying, but the disclosure is not limited thereto.

What is claimed is:

1. An optical element for multiple reflections of stray light, comprising:
a plurality of microstructures around a central axis of the optical element, wherein each of a microstructure comprises a first reflective surface and a second reflective surface which are in contact and has a connection line, wherein the connection line is a boundary line between the first reflective surface and the second reflective surface, and an extension line of the connection line passes through the central axis,
wherein the plurality of microstructures are arranged in a plurality of rings adjacent to each other, and the plurality of microstructures of two adjacent rings among the plurality of rings are alternately arranged with each other.

2. The optical element according to claim 1, wherein the microstructure is substantially a pyramid, further comprising:
a base in contact with the first reflective surface and the second reflective surface, and
an apex, wherein the connection line passes through the apex.

3. The optical element according to claim 2, wherein the base comprises an angle, less than 90°, and an extension line of an angle bisector of the angle passes through the central axis.

4. An optical element for multiple reflections of stray light, comprising:
a plurality of microstructures around a central axis of the optical element, wherein each of a microstructure comprises:
a base;
an apex; and
a first reflective surface and a second reflective surface which are in contact with each other being formed from the base to the apex, and having a connection line, wherein the connection line is a boundary line between the first reflective surface and the second reflective surface, and orthographic projections of the first reflective surface and the second reflective surface on the base form an angle,
wherein an extension line of an angle bisector of the angle passes through the central axis,
wherein the plurality of microstructures are arranged in a plurality of rings adjacent to each other, and the plurality of microstructures of two adjacent rings among the plurality of rings are alternately arranged with each other.

5. The optical element according to claim 4, wherein a spacing between the base of the plurality of microstructures is located in a same ring in the plurality of rings is smaller than a shortest side length of the base.

6. The optical element according to claim 4, wherein a reflectivity of the microstructure is less than 5%.

7. The optical element according to claim 4, wherein the optical element is a lens barrel.

8. The optical element according to claim 4, wherein the optical element is an annular optical element.

9. The optical element according to claim 4, wherein the microstructure satisfies a following relation equation:
α+β≤180°, α≥90°, β<90°, wherein α is an angle between the base and the central axis, and β is an angle between the base and the connection line.

10. The optical element according to claim 4, wherein the microstructure satisfies a following relation equation:
90°≤α≤135°, wherein α is an angle between the base and the central axis, and an angle difference between the base of each of the plurality of microstructures is less than or equal to 5°.

11. The optical element according to claim 4, wherein the microstructure satisfies a following relation equation:
90°≤α≤135°, wherein α is an angle between the base and the central axis, and a difference between a maximum length of the base of each of the plurality of microstructures is less than or equal to 5%.

12. The optical element according to claim 4, wherein α shape of the base is substantially a triangle.

13. The optical element according to claim 4, wherein the microstructure satisfies a following relation equation:
55°≤θ≤65°, wherein θ is a magnitude of the angle of the base.

14. The optical element according to claim 4, wherein the microstructure satisfies a following relation equation:
35°≤θ≤45°, wherein θ is a magnitude of the angle of the base.

15. The optical element according to claim 4, wherein the microstructure satisfies a following relation equation:
0.45 μm/degrees≤H/θ≤9.1 μm/degrees, wherein H is a vertical height from the base to the apex, and θ is a magnitude of the angle of the base.

16. The optical element according to claim 4, wherein the microstructure satisfies a following relation equation:
0.45 μm/degrees≤L/θ≤9.1 μm/degrees, wherein L is a shortest side length of the base, and θ is a magnitude of the angle of the base.

17. The optical element according to claim 4, wherein the microstructure satisfies a following relation equation:
0.6≤H/L≤1.0, wherein H is a vertical height from the bottom to the apex, and L is a shortest side length of the base.

18. The optical element according to claim 3, wherein the microstructure satisfies a following relation equation:
α+β≤180°, α≥90°, β<90°, wherein α is an angle between the base and the central axis, and β is an angle between the base and the connection line.

19. The optical element according to claim 3, wherein the microstructure satisfies a following relation equation:
90°≤α≤135°, wherein α is an angle between the base and the central axis, and an angle difference between the base of each of the plurality of microstructures is less than or equal to 5°.

20. The optical element according to claim 3, wherein the microstructure satisfies a following relation equation:
0.6≤H/L≤1.0, wherein H is a vertical height from the bottom to the apex, and L is a shortest side length of the base.
